(19) United States
(12) Patent Application Publication
(10) Pub. No.: US 2009/0125545 A1
(43) Pub. Date: May 14, 2009

(54) METHOD FOR CONSTRUCTING KEY GRAPH FOR MULTI-GROUP MULTI-CASTING SERVICE AND MANAGING KEY

(76) Inventors: Han-Seung KOO, Daejon (KR); Yun-Jeong SONG, Daejon (KR); Soo-In LEE, Daejon (KR)

Correspondence Address: LADAS & PARRY LLP, 224 SOUTH MICHIGAN AVENUE, SUITE 1600, CHICAGO, IL, 60604, US

(21) Appl. No.: 12/167,392

(22) Filed: Jul. 3, 2008

(30) Foreign Application Priority Data
Nov. 14, 2007 (KR) 10-2007-0115869

(51) Int. Cl. G06F 7/00; G06F 17/30

(52) U.S. Cl. 707/102; 707/E17.005

(57) ABSTRACT

Provided is a method for constructing a key graph for multi-group multi-casting service and managing a key. The method includes: searching for a user group set (common group set) having the same access right to each resource combination comprising multiple resource selected from resources for a service and non-overlapping with other resource combinations by using an access right relations between user groups and the resource; and constructing a key graph by interconnecting a user group key and a resource key using the access right relation, where user groups pertaining to the searched common group set are connected to corresponding resources via intermediate nodes.

### CROSS-REFERENCE TO RELATED APPLICATIONS

The present invention claims priority of Korean Patent Application No. 10-2007-0115869, filed on Nov. 14, 2007, which is incorporated herein by reference.

### BACKGROUND OF THE INVENTION

1. Field of the Invention

The present invention relates to a method for constructing a key graph for multi-group multi-casting service and managing a key; and, more particularly, to a method for constructing a key graph for multi-group multi-casting service using access qualification relations between user groups and resources and managing a key, which is capable of minimizing overlapping of access qualification relations between user groups and resources and thereby reducing communication cost and storage cost in a conditional access system (CAS) by connecting multiple user groups, which have the same access right to multiple resources, to a corresponding resource via an intermediate node.

This work was supported by the IT R&D program of MIC/IITA [2006-S-019-02, “The Development of Digital Cable Transmission and Receive System for 1 Gbps Downstream”].

2. Description of Related Art

An Internet protocol television (IPTV) conditional access system (CAS) using Internet multi-casting scheme is operated on the basis of a multi-group multi-casting service.

The multi-group multi-casting service requires a key management scheme for generating, changing, or deleting an entitlement key in accordance with entitlements varied with user's dynamic membership.

In this key management scheme, a rekey message including a newly generated entitlement key is generated and transmitted to corresponding subscribers to ensure a forward/backward security in spite of changes of the user's dynamic membership.

A key management scheme under IPTV CAS environment as described in FIG. 1 will be fully described hereinafter.

The IPTV CAS, as described in FIG. 1, includes a key distribution center (KDC) 11 at head end. Subscribers have host terminals 12 to 14.

The subscribers to IPTV services may buy premium broadcast contents, cancel buying contents, or buy another premium contents instead through the host terminals whenever they want. This is called as a user's dynamic membership.

The KDC 11 generates and transmits rekey messages 111 to 114 including a newly generated entitlement key to the subscribers whenever receiving qualification change requests 101 to 104 from the subscribers so as to ensure the forward/backward security whenever the user's dynamic membership occurs.

The scheme, which generates and transmits the rekey message whenever the user's dynamic membership occurs, results in increases of system costs such as communication cost and storage cost.

A conventional multi-group (MG) scheme has been proposed to solve this problem, which uses a key graph to reduce the communication cost and the storage cost when a KDC 11 generates and transmits a rekey message in accordance with changes of the user's dynamic membership in multi-group multi-casting service such as IPTV premium broadcast service.

The conventional MG scheme generates a hierarchical key graph (HKG) united into one, which searches for overlapped relations in access right relations between user groups and resources, and removes the overlapped relations. When using the key graph as described above, it is possible not only to reduce the required number of keys, but also to generate a rekey message including a smaller amount of data.

However, the conventional MG scheme uses a binary tree graph to construct the HKG, which results in a greater number of intermediate nodes. This causes the complexity of the HKG and increases a storage/communication overhead.

Moreover, the conventional MG scheme searches the binary tree graph for the attributes of overlapped access right relations between the user groups and the resources, which causes lower search efficiency.

Accordingly, the core of the MG scheme is to find how many of the overlapped relations there are and how to reflect the found overlapped relations efficiently in the key graph.

A configuration of the key graph, which is capable of minimizing the number of intermediate nodes, is absolutely necessary for efficient key management in accordance with the user's dynamic membership in the IPTV premium broadcast service.

### SUMMARY OF THE INVENTION

An embodiment of the present invention is directed to providing a method for constructing a key graph for multi-group multi-casting service using access qualification relations between user groups and resources and managing a key, to solve problems that cause increases of communication cost and storage cost in a conditional access system due to inefficient overlapping in a key graph representing an access right relations between user groups and resources.

Another embodiment of the present invention is directed to providing a method for constructing a key graph for multi-group multi-casting service using access qualification relations between user groups and resources and managing a key, which is capable of minimizing overlapping of access qualification relations between user groups and resources and thereby reducing communication cost and storage cost in a conditional access system (CAS) by connecting multiple user groups, which have the same access right to multiple resources, to a corresponding resource via an intermediate node.

In accordance with an aspect of the present invention, there is provided a method for constructing a key graph for multi-group multi-casting service, the method including: searching for a user group set (common group set) having the same access right to each resource combination including multiple resource selected from resources for a service and non-overlapping with other resource combinations by using an access right relations between user groups and the resource; and constructing a key graph by interconnecting a user group key and a resource key using the access right relation, where user groups pertaining to the searched common group set are connected to corresponding resources via intermediate nodes.

In accordance with another aspect of the present invention, there is provided a method for managing a key for multi-group multi-casting service in a conditional access system, the method including: constructing a key graph using access right relations between user groups and resources, where a user group set (common group set) having the same access right to each resource combination and non-overlapping with other resource combinations are interconnected via intermediate nodes; and managing the key by distributing the key in accordance with the key graph and updating a corresponding key using the key graph when a user qualification is changed, and transmitting the updated key to a user.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a diagram illustrating a general IPTV conditional access system.

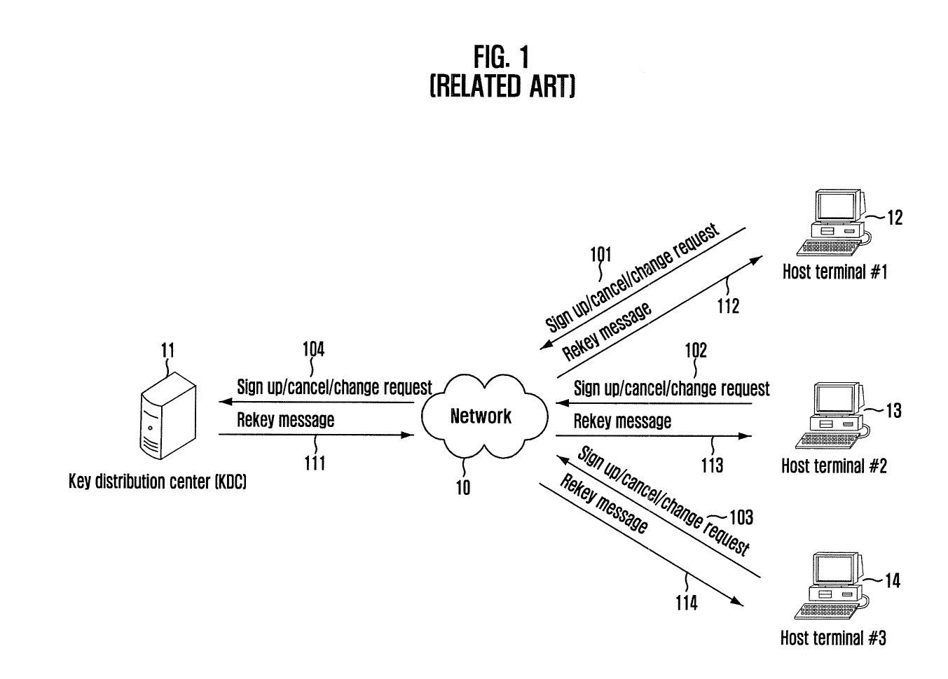

FIG. 2 is a table illustrating access right relations between resources and user groups for a multi-group multi-casting service in accordance with an embodiment of the present invention.

FIG. 3 is a diagram illustrating a method for constructing a key graph connecting between resource keys and group keys in accordance with an embodiment of present invention.

FIG. 4 is a flowchart illustrating a method for constructing a key graph for a multi-group multi-casting service in accordance with an embodiment of the present invention.

FIG. 5 is a flowchart illustrating a method for managing key for a multi-group multi-casting service in accordance with an embodiment of the present invention.

FIG. 6 is a diagram illustrating a method for renewing a key using the key graph in FIG. 4 in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter.

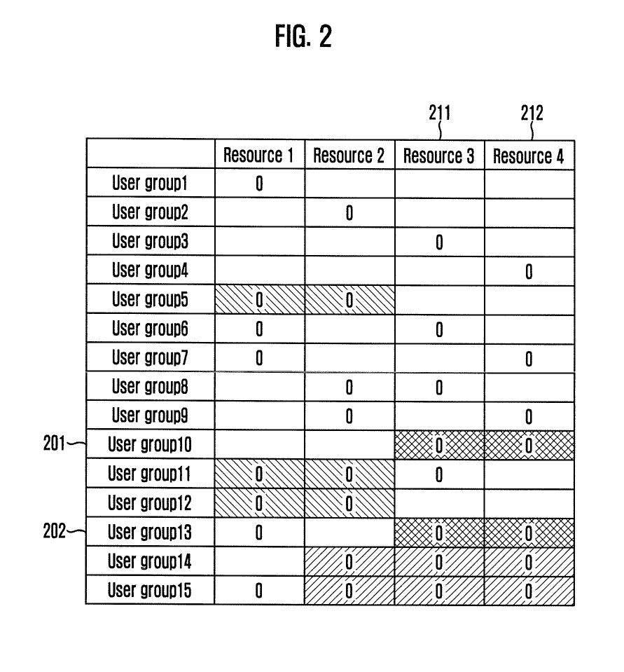

FIG. 2 is a table illustrating access right relations between resources and user groups for a multi-group multi-casting service in accordance with an embodiment of the present invention.

An IPTV conditional access system uses a concept called a user group, which groups users having the same access right to resources such as premium broadcast contents (e.g., contents such as sports, stock) to efficiently manage subscribers as illustrated FIG. 2.

An embodiment as illustrated in FIG. 2, represents an access right relation between the user groups and four resources. The same shaped hatched parts represent user groups having the same access right.

For example, a user group 10 and a user group 13 represent a group including users having the same access right to resources 3 and 4.

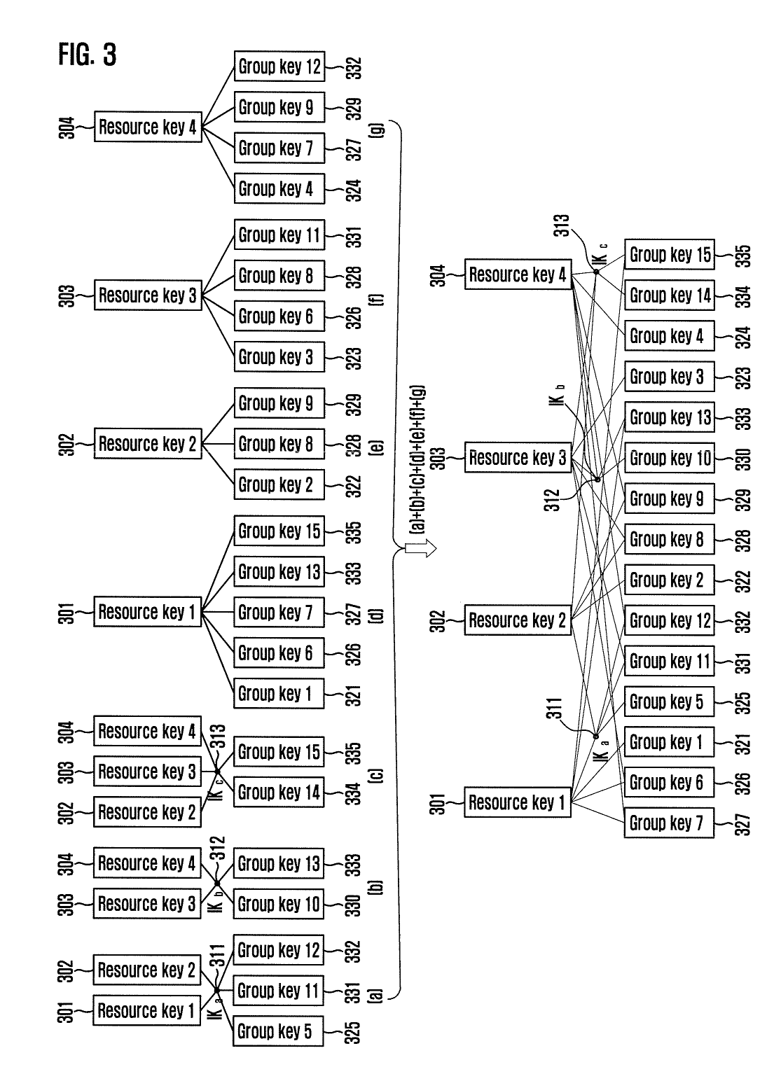

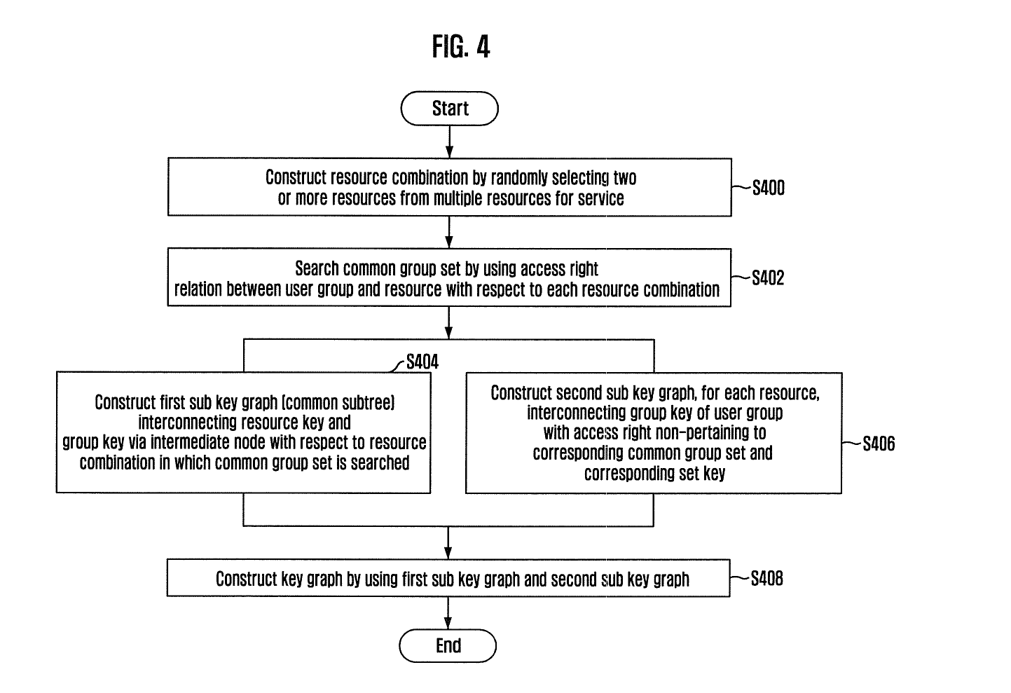

FIG. 3 is a diagram illustrating a method for constructing a key graph connecting between resource keys and group keys in accordance with an embodiment of present invention. FIG. 4 is a flowchart illustrating a method for constructing a key graph for a multi-group multi-casting service in accordance with an embodiment of the present invention. Hereinafter, the method for constructing a key graph will be described with reference to FIGS. 3 and 4 together.

The number of offspring nodes for each node in the key graph is minimized using a concept called a common subtree. This reduces the size of rekey message to be transmitted to a user in accordance with a user's dynamic membership. The common subtree, which is a key subtree for user groups having the same access right to two or more resources, represents overlapped access relations between the user groups and the resources.

As illustrated in FIG. 3, the method in accordance with this embodiment has the characteristic of connecting user groups to corresponding resources using intermediate nodes 311 to 313 after searching for the user groups corresponding to the common subtree ((a), (b), and (c) in FIG. 3).

When using the intermediate nodes 311 to 313, the method can efficiently reduce the number of paths connected from Resource_Key nodes to the intermediate nodes 311 to 313 and the number of paths connected from the intermediate nodes 311 to 313 to Group_Key nodes.

The method for constructing the key graph in accordance with this embodiment is performed in accordance with the following two phases.

A first phase is a process of constituting each resource combination including two or more resources randomly selected from multiple resources and searching for user group set (hereinafter, referred to as a Common_group Set (CS)) having the same access right and non-overlapping with other resource combination using the access right relations between the user groups and resources. The multiple CSs are referred to as a Common_Group Set group (CSG).

A second phase is a process of constituting a key graph by connecting user group keys to resource keys based on the access right relation between the user groups and the resources, and connecting the user groups, which pertain to the CS obtained from the first phase, to corresponding resources via the intermediate nodes.

Hereinafter, the method for constructing the key graph performed in the CAS (more exactly, KDC 11) will be described with reference to FIG. 4.

In operation S400, the CAS constitutes resource combination including two or more resources randomly selected from multiple resources. Then, in operation S402, the CAS searches for the CS using the access right relations between the user groups and the resource with respect to each resource combination.

Looking at the order of searching the resource combination, a resource combination including more resources is preferentially searched for corresponding CS. When the resource combinations have the same number of the resources, a resource combination, which has the largest number of user groups with the same access right, is preferentially determined as the CS.

To remove the overlapping between the CSs, user groups commonly pertaining to other preferentially determined CSs as well are excluded from the user groups with the same access right searched for a specific resource combination. Then, the residual user groups are determined as a corresponding CS.

After completing the CS search process, in operation S404, the CAS constructs a first sub key graph (common subtree) ((a), (b), and (c) in FIG. 3) by connecting the resource keys to the group keys via the intermediate nodes with respect to the resource combination searched for the CS.

That is, the CAS constructs the first sub key graph in which the corresponding resource key and group key are respectively set to a root node and a leaf node with respect to each resource combination searched for the CS in operation S402. At this time, the root nodes are connected to the leaf nodes via corresponding intermediate nodes (311, 312, and 313).

In operation S406, the CAS constructs a second sub key graph ((d), (e), (f), and (g) in FIG. 3) in which group keys of user group with an access right non-pertaining to corresponding CS are connected to corresponding resources keys.

That is, the CAS constructs the second sub key graph in which the corresponding group key of the user group with an access right non-pertaining to corresponding CS and the resource key are respectively set to a leaf node and a root node with respect to each resource.

Then, in operation S408, the CAS constructs a key graph ((a)+(b)+(c)+(d)+(e)+(f)+(g) in FIG. 3) by combining the first sub key graph and the second sub key graph. In this case, the resource keys 301 and 302 and the group keys 321 to 335 are used once for each type.

The method for constructing the key graph in accordance with an embodiment of the present invention as illustrated in FIG. 4 can be expressed in the following pseudocode form:

```
// The First Phase: Find CS and CSG
i = 1, m = T
while m != 1
  do Find ψ_{T,m}
  while MAX(ψ_{T,m}) != null
    if (UGS(MAX(ψ_{T,m})) ∩ CSG) == ø, then
        do Add (UGS(MAX(ψ_{T,m})) to CS(m, i)
        do Add CS(m, i) to CSG
    end if
      do ψ_{T,m} = ψ_{T,m} − MAX(ψ_{T,m})
      do Increase ‘i’ by 1
  end while
    do Set ‘i’ to ‘1’
    do Decrease ‘m’ by ‘1’
end while
// The Second Phase: Construct Key Graph
j = 1
while j <=n(CSG)
  do Find Resource_Key(CSG(j)) and Group_Key(CSG(j))
  do Construct ‘sub key graph’ using Resource_Key(CSG(j)) as
    Roots and Group_Key(CSG(j)) as Leaves
  do Increase ‘j’ by ‘1’
end while
k = 1
while k <= T
  do Find UG(Resource_Keyₖ)=UG(Rₖ)−Rₖ(CSG)
  do Construct ‘sub key graph’ using Group Keys related to
    UG(Resource_Keyₖ)as Leaves, and Resource_Keyₖ as a Root
  do Increase ‘k’ by ‘1’
end while
do Merge all ‘sub key graph’ by using ’Resource Keys’ and ’Group
  Keys’ once, and make a ‘key graph’
```

Hereinafter, definitions of parameters used in the above algorithm will be described as follows.
Resource_Key: This means a key used for encoding resources, to each of which one different Resource_Key is assigned.
Group_key: This means a key for representing a qualification of a user group. The Group_Key is used to encode the Resource_Key to be sent to users. One different Group_Key is assigned to each user group.
T: This means the total number of the resources supported in multi-group multi-casting service. For example, T=4 in FIG. 2.
CS(m, i): This represents Common_group Set, which means an i-th set among multiple sets including user groups having the same access right to m (a positive integer larger than 1) number of resources and does not share common user group with other sets except the i-th set. That is, the CS represent a user group set having the same access right to a specific resource combination and at the same time non-overlapping with other resource combination. For example, CS(2, 1) may be {UG₅, UG₁₁, UG₁₂}, and CS(2, 2) may be {UG₁₀, UG₁₃}, where UG means a user group.
CSG: This means a common set group, which is constituted of CSs.
ψ_{T,m}: This means a set including the number of all cases of selecting m number of resource from T number of resources. That is, it means a set constituted of resource combinations. For example, when three resources {R₁, R₂, R₃} exist, ψ_{3,2} corresponds to {R₁, R₂}, {R₁, R₃}, {R₂, R₃}, each of which is a resource combination.
MAX (ψ_{T,m}): This means an element including the largest number of user groups having the same access right to corresponding resources among elements of ψ_{T,m}. For example, provided that ψ_{T,m}={{R₁, R₂}, {R₁, R₃}, {R₂, R₃}} and the user groups having the same access right to resources corresponding to each element is {UG₅, UG₁₁, UG₁₂}, {UG₁₀, UG₁₃}, {UG₃}, respectively, MAX(ψ_{T,m}) becomes {R₁, R₂}.
UGS(MAX(ψ_{T,m})): This means user groups having the same access right to elements (that is, resources) corresponding to MAX(ψ_{T,m}). For example, UGS(MAX(ψ_{3,2})) becomes {UG₅, UG₁₁, UG₁₂}
Resource_Key (CSG(j)): This means a Resource_Key assigned to resources accessible by all user groups which a j-th CS (m, i) in the CSG indicates.
Group_Key (CSG(j)): This means Group_Keys assigned to each of user groups which a j-th CS (m, i) in the CSG indicates.
UG(Resource_Keyₖ): This represents residual user group set after excluding all user groups (Rₖ(CSG)) of CSG having an access right to a k-th resource from user groups (UG(Rₖ)) having an access right to Resource_Key assigned to k-th resource
UG(Rₖ): This means user groups having an access right to a Resource_Key assigned to k-th resource.
Rₖ(CSG): This means all user groups of CSG having an access right to k-th resource.

When the method for constructing a key graph in accordance with an embodiment of the present invention is concretely applied to a multi-group multi-casting service having an access relation as illustrated in FIG. 2, the key graph is constructed as illustrated in FIG. 3. At this time, parameter values obtained from the first and second phases are described in the following Table 1.

TABLE 1

| | |
|---|---|
| CS | CS(3,1) = {UG₁₄, UG₁₅} |
| | CS(2,1) = {UG₅, UG₁₁, UG₁₂} |
| | CS(2,2) = {UG₁₀, UG₁₃} |
| CSG | CSG = {CS(3,1), CS(2,1), CS(2,2)} |
| Resource_Key | Resource_Key(CSG(1)) = {Resource_Key₁, |
| (CSG) | Resource_Key₂} |
| | Resource_Key(CSG(2)) = {Resource_Key₃, |
| | Resource_Key₄} |
| | Resource_Key(CSG(3)) = {Resource_Key₂, |
| | Resource_Key₃, Resource_Key₄} |
| Group_Key | Group_Key(CSG(1)) = {Group_Key₅, |
| (CSG) | Group_Key₁₁, Group_Key₁₂} |
| | Group_Key(CSG(2)) = {Group_Key₁₀, |
| | Group_Key₁₃} |
| | Group_Key(CSG(3)) = (Group_Key₁₄, |
| | Group_Key₁₅} |
| UG | UG (Resource_Key₁) = {UG₁, UG₆, UG₇, UG₁₃, |
| (Resource_Key) | UG₁₅} |
| | UG(Resource_Key₂) = {UG₂, UG₈, UG₉} |
| | UG(Resource_Key₃) = {UG₃, UG₆, UG₈, UG₁₁} |
| | UG(Resource_Key₄) = {UG₄, UG₇, UG₉, UG₁₂} |

If Resource_Key (CSG(j)) and a Group_Key (CSG(j)) obtained from an algorithm of the present invention are interconnected via intermediate nodes 311, 312 and 313, a first sub key graph is constructed such as (a), (b), and (c) illustrated in FIG. 3. Intermediate keys IK are assigned to the intermediate nodes 311, 312 and 313.

If Group_Keys and Resource_Keyₖs corresponding to each element of UG (Resource_Keyₖ) as previously obtained are interconnected, a second sub key graph is constructed such as (d), (e), (f) and (g) illustrated in FIG. 3.

Finally, all of the previous sub key graphs are united into one key graph. Each of the Resource_Keys and each of the Group_Keys must be used only once.

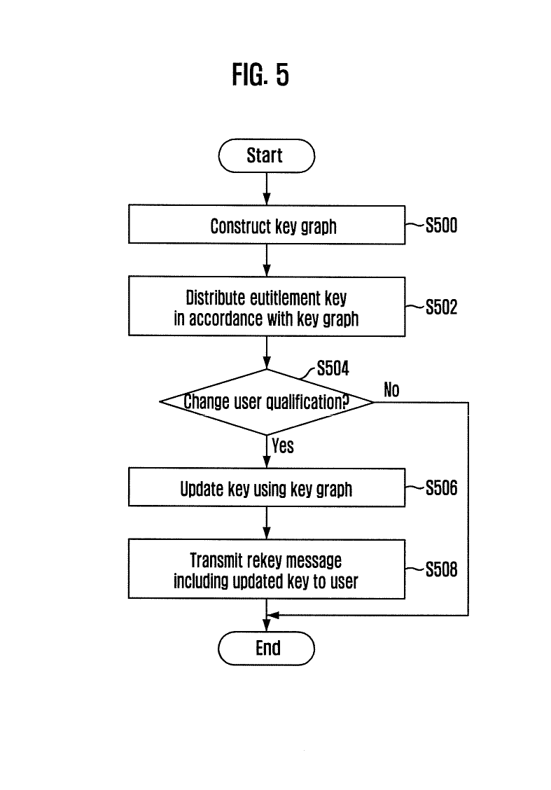

FIG. 5 is a flowchart illustrating a method for managing key for a multi-group multi-casting service in accordance with an embodiment of the present invention.

The method in accordance with an embodiment of the present invention has the characteristic of generating and transmitting a rekey message whenever a user's dynamic membership (qualification change) occurs, based on the key graph finally completed through all process as described above.

When the key graph (refer to FIG. 3) is constructed in accordance with the embodiment as illustrated in FIG. 4 in operation S500, the CAS (more exactly, KDC 11) distributes entitlement keys to user in accordance with the key graph in operation S502.

It is checked in operation S504 whether the qualification of a user is changed. If positive, in operation S506, the CAS updates the entitlement key using the key graph. Then, in operation S508, the CAS transmits a rekey message including the updated entitlement key to the user.

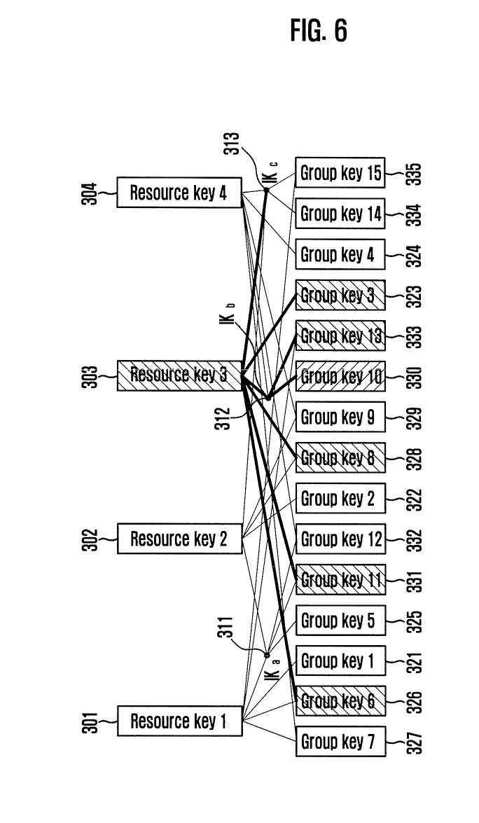

FIG. 6 is a diagram illustrating a method for renewing a key using the key graph in FIG. 4 in accordance with an embodiment of the present invention.

Hereinafter will be described a case where a user included in a user group 10 withdraws.

A keyset subject to an update, that is, a keyset of a user group 10 including a qualification changed user is searched. The keyset means a set of keys which the qualification changed user located at an end node of the key graph must include, which includes all the keys placed on a path from a key assigned to the end node including the user to a root node. As illustrated in FIG. 6, keys on a path from a key (group key 3) of a user group including the qualification changed user to a Resource_Key 3 303, that is, IKb 312 and the Resource_Key 3 303 are included in a keyset.

The keyset, that is, {IKb, Resource_Key 3} is updated to IKₕ^{new}, Resource−Key₃^{new}.

Then, sub keys connected to the updated keys (IKₕ^{new}, Resource−Key₃^{new}) 303 and 312 is searched for on the key graph. The updated keys (IKₕ^{new}, Resource−Key₃^{new}) included in the keyset are encoded with the found sub keys. As a case where the user withdrew from the user group 10 330, it is natural that corresponding group key 10 would be updated.

That is, the IKₕ^{new} 312 is encoded into a group key 10 330 and a group key 13 333 corresponding to its sub keys. The Resource−Key₃^{new} 303 is encoded into IKₕ 312, a group key 6 326, a group key 11 331, a group key 8 328, a group key 3 323, and IK_{c} 313 corresponding to its sub keys.

This encoding relations can be symbolically expressed as follows:

{IK}Group−Key₁₀^{new} \textcircled{1}

{IKₕ^{new}}Group−Key₁₃ \textcircled{2}

{Resource−Key₃^{new}}IKₕ^{new} \textcircled{3}

{Resource−Key₃^{new}}Group_Key₆ \textcircled{4}

{Resource−Key₃^{new}}Group_Key₁₁ \textcircled{5}

{Resource−Key₃^{new}}Group_Key₈ \textcircled{6}

{Resource−Key₃^{new}}Group_Key₃ \textcircled{7}

{Resource−Key₃^{new}}IK_{c} \textcircled{8}

Where {A}B means that A is encoded into an encoding key B, and A^{new} means that A is updated.

In this case, the size of a rekey message can be expressed as 8, which becomes a communication cost value.

The methods for constructing a key graph for multi-group multi-casting service in accordance with the embodiments of the present invention may be programmed in a computer language. Codes and code segments constituting the computer program may be easily inferred by a computer programmer skilled in the art. Furthermore, the computer program may be stored in a computer-readable recording medium including all kinds of media such as CD-ROM, RAM, ROM, floppy disk, hard disk and magneto-optical disk, and read and executed by a computer to embody the methods.

While the present invention has been described with respect to the specific embodiments, it will be apparent to those skilled in the art that various changes and modifications may be made without departing from the spirit and scope of the invention as defined in the following claims.

What is claimed is:

1. A method for constructing a key graph for multi-group multi-casting service, the method comprising:
searching for a user group set (common group set) having the same access right to each resource combination comprising multiple resource selected from resources for a service and non-overlapping with other resource combinations by using an access right relations between user groups and the resource; and
constructing a key graph by interconnecting a user group key and a resource key using the access right relation, where user groups pertaining to the searched common group set are connected to corresponding resources via intermediate nodes.

2. The method of claim 1, wherein said searching of the common group set comprises preferentially searching for a common group set corresponding to a resource combination comprising the larger number of the resources.

3. The method of claim 2, wherein said searching of the common group set comprises determining residual user groups as the corresponding common group set after excluding user groups commonly pertaining to other preferentially determined common group set as well from searched user groups having the same access right with respect to a specific resource combination.

4. The method of claim 3, wherein said searching of the common group set comprises determining user groups comprising the larger number of user groups having the same access right as the common group set when resource combinations comprises the same number of resources.

5. The method of claim 1, wherein said constructing of the key graph comprises constructing a first sub key graph in which corresponding resource key and corresponding group key is set to a root node and a leaf node with respective to each resource combination searched for common group set, respectively, where the root node and the leaf node are interconnected via corresponding immediately node.

6. The method of claim 5, wherein said constructing of the key graph comprises constructing a second sub key graph in which a group key with respect to the user group with an access right non-pertaining to corresponding common group set and the corresponding resource key are set to a leaf node and a root node with respect to each resource, respectively.

7. The method of claim 6, wherein said constructing of the key graph comprises constructing the key graph by combining the first sub key graph and the second sub key graph, where the resource key and the group key are used only once for each type.

8. A method for managing a key for multi-group multi-casting service in a conditional access system, the method comprising:
constructing a key graph using access right relations between user groups and resources, where a user group set (common group set) having the same access right to each resource combination and non-overlapping with other resource combinations are interconnected via intermediate nodes; and
managing the key by distributing the key in accordance with the key graph and updating a corresponding key using the key graph when a user qualification is changed, and transmitting the updated key to a user.

9. The method of claim 8, wherein said constructing of the key graph comprises:
searching for a corresponding common group set using the access right relation, with respect to each resource combination comprising multiple resource selected from resources for a service; and
constructing the key graph by interconnecting a user group key and a resource key using the access right relation, where user groups pertaining to the searched common group set are connected to corresponding resources via intermediate nodes.

10. The method of claim 8, wherein said managing of the key comprises updating the key by searching for an intermediate key and a resource key placed on a path from a group key (leaf node) with respect to a qualification changed user to a corresponding resource key (root node) on the key graph.

11. The method of claim 10, wherein said managing of the key comprises transmitting a rekey message to the user, the rekey message comprising a corresponding sub key encoded from the updated intermediate key and resource key on the key graph.
